(19) United States
(12) Patent Application Publication
(10) Pub. No.: US 2011/0184787 A1
(43) Pub. Date: Jul. 28, 2011

(54) Method, Apparatus and System for Monitoring Computing Apparatus

(76) Inventors: John Morrison, Manchester (GB); Christopher Povey, Cheshire (GB)

(21) Appl. No.: 11/576,623

(22) PCT Filed: Oct. 4, 2005
(86) PCT No.: PCT/GB05/03830

§ 371 Date: Aug. 23, 2007

Related U.S. Application Data
(60) Provisional application No. 60/621,734, filed on Oct. 25, 2004.
(60) Provisional application No. 60/621,734, filed on Oct. 25, 2004.

(30) Foreign Application Priority Data
Oct. 4, 2004 (GB) 0422059.6

(51) Int. Cl. G07C 13/00; H04N 9/80

(52) U.S. Cl. 705/12; 386/239; 386/252

(57) ABSTRACT

A system for validating electronic voting made via computer apparatus comprises a device configured to connect to the computer apparatus and store data output by the computer apparatus. A separate processing device is configured to connect with the device and analyse the stored data to determine the validity of the voting.

### FIELD OF THE INVENTION

The present invention relates to a method, apparatus and system for monitoring computing apparatus, specifically user interaction with the computing apparatus. The method and apparatus may provide independent recordal of a user's actions and/or subsequent analysis of the user interaction.

### BACKGROUND OF THE INVENTION

The need to monitor and independently audit (at a later time), the interactions of a user or groups of users interacting with computer terminals and other electronic systems which include display devices is evident in many spheres of activity which involve interaction with computing apparatus. Some examples are use of automatic teller machines, shop registers and electronic voting equipment.

“Independent” monitoring means monitoring a user's interactions without employing software running on the computing device or hardware in the computing apparatus.

“Computing apparatus” means any electronic apparatus which has a connected input device and display screen allowing a user interaction with the electronic apparatus.

“User interaction” means manipulation of components within a user interface displayed on the display screen of the computing apparatus.

Existing approaches for monitoring user interaction employ additional electronic hardware and/or software within the computing equipment. All of these existing approaches are potentially open to compromise and fail to provide complete, transparent and independent verification of a user's actions.

One aim of the invention is to provide a method and apparatus for independent monitoring of user interaction with computing equipment.

A further aim of the present invention is to provide a method and apparatus for analysing data obtained from monitoring user interaction with computing equipment.

Yet a further aim of the present invention is to provide a method and apparatus for secure monitoring of user interaction with computing equipment.

### SUMMARY OF THE INVENTION

In accordance with the foregoing, in a first aspect, the present invention provides apparatus for receiving images from a video generation device comprising:

a video link through which a video signal from a video generation device is received in use;

a memory for storing video data; and

a processor connected to the video link configured to sample frames in the video signal, to process sampled frames to generate video data for storage in the memory and further configured to embed an identification tag within the video data.

Thus, the present invention allows data to be extracted from display screens of computing apparatus so that it can be used to independently verify the internal data of the computing apparatus and the authenticity of the video data can be checked.

The apparatus may be portable. This may mean handheld so that it can be easily and unobtrusively connected to the video generation device. In this regard, portable generally means less than 10 cm in length and less then 5 cm in width and depth.

Preferably, the identification tag characterises the apparatus being used. In this way, each frame sampled by the apparatus is securely identified by the apparatus it was recorded by.

The processor may be configured to embed the identification tag in every frame stored in the memory.

Preferably, each image corresponds to a screen of a user interface generated by the video generation device.

In one embodiment of the present invention, the processor is configured to store in the memory only video data for sampled frames differing to a previously sampled frame. This way, the amount of memory required can be reduced.

In one embodiment of the present invention, the processor is configured to embed the identification tag as a digital signature within the video data.

In another embodiment of the present invention, the processor is configured to embed the identification tag a graphical identification tag within the video data. The graphical identification tag comprises a watermark image for embedding in a frame of the video data.

In one embodiment of the present invention, the processor is further configured to encrypt the identification tag before embedding the identification tag in the video data.

Preferably, the processor is configured to encrypt the identification tag using a public key stored in the memory of the image generation device.

The video generation unit is preferably computing apparatus with an analogue video output (e.g. in Video Graphics Array (“VGA”) format). The computing apparatus may be configured to execute electronic voting system software which generates voting data on the computing apparatus. In this way, the apparatus can be used to independently verify the validity of the voting data.

In a second aspect of the present invention, there is provided a method for storing images from a video generation device comprising the steps of:

receiving a video signal from a video generation device at a sampling device;

sampling frames encoded in the video signal;

embedding an identification tag within the video data of the video signal; and

storing the video data in memory.

Preferably, the identification tag characterises the sampling device.

In one embodiment of the present invention, the step of embedding comprises the steps of:

generating a digital signature; and

inserting the digital signature into the video data.

In another embodiment of the present invention, the step of embedding comprises the steps of:

generating a graphical identification tag; and

applying the graphical identification tag to the video data.

The method may further comprise the steps of:

connecting the sampling device to a processing device after storing video data in the memory;

receiving into the processing device the stored video data from the memory; and

in the processing device, analysing the stored video data to determine the presence in the video data of at least one identification tag, thereby determining whether the video data has been tampered with.

Preferably, the step of analysing comprises determining whether every image in the video data includes the identification tag.

The method may comprise the step of decrypting and encrypted identification tag by applying a private key stored in the processing unit to the identification tag.

In a third aspect of the present invention, there is provided a system for analysing video data generated by a video generation device comprising:

the aforementioned apparatus; and

a processing unit for connecting to the apparatus and configured to receive the stored video data from the memory of the apparatus and analyse the stored video data to determine the presence in the video data of at least one identification tag, thereby determining whether the video data has been tampered with.

In a fourth aspect, there is provided a method for analysing stored video data including a plurality of sampled video frames of a user interface, comprising:

identifying a significant frame within the plurality of sampled video frames;

extracting a significant region within the identified significant frame;

analysing the extracted significant region to extract data representative of user interaction with the user interface.

The extracted data may be used to create a set of statistical reports which can be compared with the internal data of the computing apparatus. The extracted data may be used to: uniquely identify the computing apparatus used, capture any misuse or tampering of the computing apparatus, confirm the time and date of the operation of computing apparatus, provide complete video playback of a source apparatus operation for manual verification, confirm the location of the computing apparatus, capture any additional data of interest from the computing apparatus for verification processes and verify the integrity of the video data.

In one embodiment of the present invention, the step of analysing comprises identifying a change in characteristic of the significant region. Preferably, the change in characteristic is a change in colour or texture of the significant region.

The step of analysing may comprise processing video data for the identified significant region to extract data input via the user interface. Preferably, the step of analysing comprises processing video data for the identified significant region to extract identification data for graphical markers inserted into the video data by a sampling device, which may include determining the identity of the sampling device from the identification data wherein the step of determining the identity comprises decrypting an identification tag from the identification data.

In one embodiment of the present invention, the step of analysing comprises determining the number of occurrences of a significant region within an identified significant frame.

The step of identifying a significant frame may comprise comparing each sampled video frame to image data representative of a section of a significant frame.

Alternatively, the step of identifying a significant frame comprises comparing each sampled video frame to image data representative of the whole of a significant frame.

In one embodiment of the present invention, the step of extracting comprises extracting a region of the identified significant frame defined by coordinates specifying a position and size of the significant region.

In another embodiment of the present invention, the step of extracting comprises extracting a region of the identified significant frame defined by one or more characteristics of the identified significant frame. Preferably, one of the characteristics is a colour or texture of the identified significant frame.

The method may further comprise the step of analysing the identified significant region to extract data corresponding to the sampling of the video frames.

In a fifth aspect of the present invention, there is provided a computer program comprising computer executable instructions for implementing the aforementioned method.

In a sixth aspect of the present invention, there is provided a processing unit configured to perform the steps of the aforementioned method.

In a seventh aspect, there is provided a system for validating electronic voting made via computer apparatus which records votes as first data, comprising:

a sampling device configured to connect to the computer apparatus and store second data representative of the votes independently from the first data; and

a processing device configured to connect with the device and analyse the stored second data to determine the validity of the voting.

The first data is data generated and stored by the computing apparatus as a result of the electronic voting taking place on the computing apparatus. In contrast, the second data is data extracted independently of the hardware and apparatus of the computing apparatus which implements the electronic voting.

The processing device is configured to determine the validity of the voting by comparing the first data to the second data. Both the first and second data may be analysed by the processing device following completion of voting.

The processing device may indicate that the voting is invalid if results of voting ascertained from the first data differ from results of voting ascertained from the second data.

The processing device and the sampling device may both comprise a wireless transceiver and connect to each other over wireless link.

Preferably, the first data is video data comprising images of a user interface displayed by the computing apparatus for voting.

In an eighth aspect of the present invention, there is provided a method for validating electronic voting made via computer apparatus, comprising:

storing independently from the computer apparatus data on the; and

analysing the stored data to determine the validity of the voting.

### BRIEF DESCRIPTION OF DRAWINGS

The present invention is now described by way of reference to the accompanying drawings, in which:

FIG. 1 shows a first embodiment of the system and apparatus of the present invention present invention;

FIG. 2 shows a second embodiment of the system and apparatus of the present invention;

FIG. 3 shows how an identification tag is encrypted and inserted into video data and decrypted by the apparatus, method and system of the present invention;

FIG. 4 shows one application of the present invention in sampling and analysing screens from an electronic voting system;

FIG. 5 shows how a unique key can be used to identify a sampled frame;

FIG. 6 shows how data can be extracted from identified frames in one embodiment of the present invention;

FIG. 7 shows how data can be extracted from an identified frame in an alternative embodiment of the present invention;

FIG. 8 shows how the data extracted in the embodiment of FIG. 7 is displayed;

FIG. 9 shows an alternative embodiment of the present invention of FIG. 2;

FIG. 10 shows a flowchart of one embodiment of the method of the present invention; and

FIG. 11 shows a flowchart of an alternative embodiment of the method of the present invention.

### DETAILED DESCRIPTION OF THE DRAWINGS

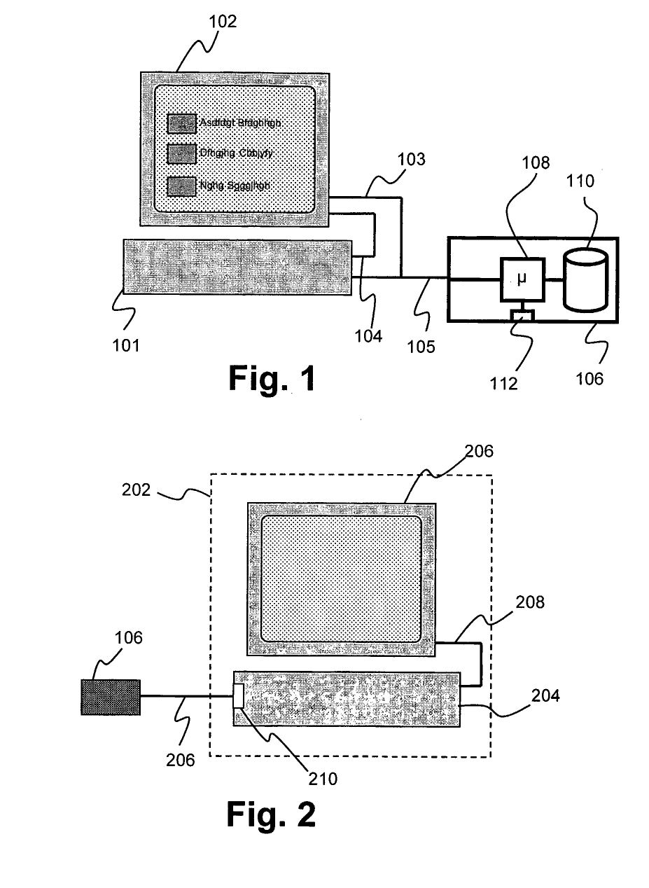

FIG. 1 shows a system for monitoring a video generation device according to the present invention. A user (not shown) interacts with computing apparatus (101). User interaction occurs through a display (102) connected to the computing apparatus (101) by a first video connection (103). The results of user interactions are displayed in the display (102). In the embodiment shown in FIG. 1, the display (102) is a touch-sensitive screen and the user interacts with the computing apparatus (101) via the touch-sensitive screen. The video connection (103) is shown in this embodiment as an electrical connection on a physical cable.

The output from the display (102) (as a result of user interaction with the display (102)) is relayed back to the computing apparatus (101) by a second electrical connection (104). In this way, the actions of the user are identified by the computing apparatus (101) and the user can interact with it.

A sampling device (106) is shown connected to the video connection (103) via video link (105). The video link (105) is shown as a cable integrated with the video connection (103). However, it should be appreciated that the video link (105) may be any form of connection to the video output of the computing apparatus (101).

There is no other connection between the sampling device (106) and the computing apparatus (101) for the transfer of information. In this way, the computing apparatus (101) cannot modify the information that is displayed to the user and neither can the sampling device (106) modify the information processed or recorded by the computing apparatus (101).

The sampling device (106) is shown as comprising a processor (108) and a memory (110). The processor (108) is connected to the video link (105) and to the memory (110).

In addition, there is an device input/output (I/O) port (112) connected to the processor (108). The memory (110) may comprise both volatile memory for use by the processor (108) as short-term data storage when processing video data and non-volatile memory, for example flash-type memory for longer term storage of processed video data.

The processor (108) receives a video signal from the video generation unit (e.g. computing apparatus (101) via the video link (105). The processor (108) captures the video signal and identifies and extracts individual frames from the signal. The individual frames are stored directly in the memory (110) by the processor (108).

In an alternative embodiment, the processor (108) may discard frames which do not differ from the previously extracted frame.

In yet a further alternative embodiment, the processor (108) may isolate frames corresponding to screen displays of interest and store only these screens in the memory (110).

In this way, the sampling device (106) can record (i) continuously the display output from the computing apparatus (101), or (ii) only screen displays of interest.

“Screen displays of interest” (significant frames) are defined as screens in which there is interaction between a user and the computing apparatus (101), or screens which are necessary for subsequent analysis of the stored video data to determine the transactions undertaken using the computing apparatus (101).

The sampled frames are compressed using a non-proprietary algorithm (e.g. MPEG-IV (Moving Picture Experts Group)), encrypted and stored as a file in the memory (110). The encryption of the video data ensures that the recorded images are recorded on an individually and uniquely identified sampling device and that they have not been modified in any way.

The sampling device (106) can be detached and its stored data transferred, probably at a remote location, to a data processing device (see FIG. 2 and the related discussion below).

FIG. 2 shows the arrangement for transfer of data from the sampling device (106) to a data processing device (202). In the embodiment shown in FIG. 2, the data processing device (202) is secondary computing apparatus with a processing unit (204) and display screen (206).

The processing unit (204) has a processing unit input/output (I/O) port (210) to which the device input/output (I/O) port (112) of the sampling device can be connected via an electrical connection (206) (e.g. Universal Serial Bus (USB) connection), wireless-link or other known form of communication link. The processing unit (204) executes software to analyse data received with the processing unit I/O port (210) and display results of the analysis on the display screen (206).

When the sampling device (106) is connected to the processing device (202), the processing unit (204) communicates with the processor (108) and reads the memory (110) to extract the sampled video data.

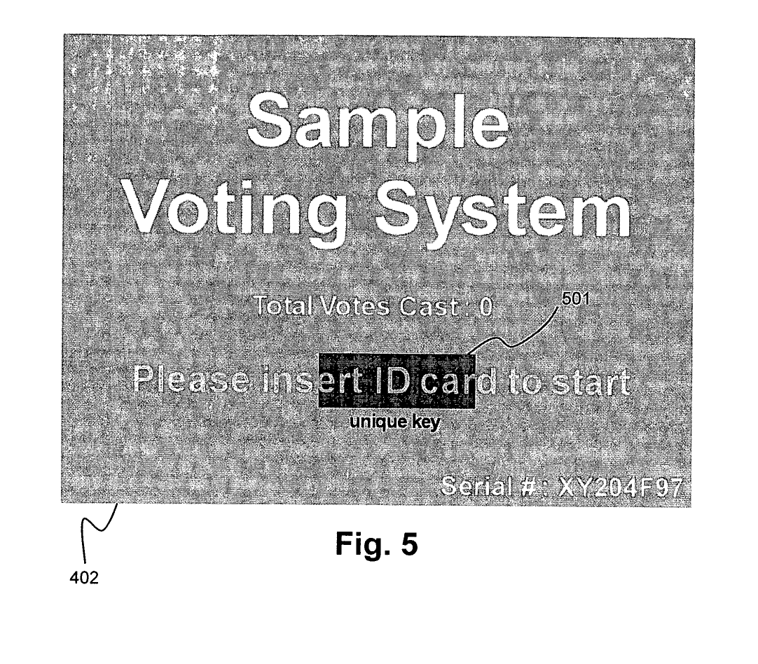

Software executing on the processing unit (204) identifies screen displays of interest (significant frames) through the use of image processing algorithms (see FIG. 5 as discussed below). The algorithms determine whether there are specified colours, text, figures, shapes or textures within each sampled frame to identify the significant frames.

Alternatively, the processor (108) of the sampling device (106) may execute the software on the sampling device in real-time as video data is being sampled. The processor (108) can then identify significant frames within the memory (110). Only the identified significant frames are then stored in memory (110).

The software of the processing unit (204) further analyses the transferred video data using image processing and optical character recognition algorithms to extract details of user transactions in textual, numeric or other formats. The resulting information can tabulated and further processed to provide information on the transaction behaviour of users who interacted with computing apparatus (101) to which the sampling device (106) was connected. The software is also executable to erase the video data in the memory (110) of the sampling device (106).

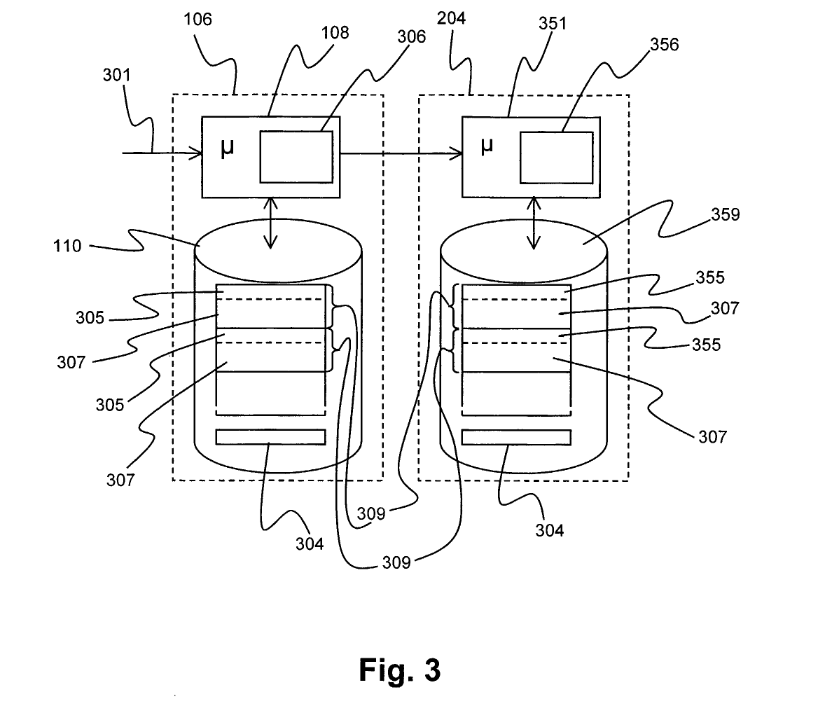

FIG. 3 shows how an identification tag (301) is inserted into the sampled video data (302) by the processor (108) of the sampling device (106). The memory (110) stores an identification code (304) which is specific to a given sampling device (106). The processor (108) reads the identification code (304) from the memory (110) and encrypts the identification code (304) along with other characteristic information with a public key (306) to generate an encrypted identification tag (305) for each frame. The encrypted identification tag (305) is stored with image data (307) as frame data (309) in the memory (110). The other characteristic information may comprise the date and time that a frame was sampled from video signal (301). The date and time of the frame are also be included in the non-encrypted image data (307) of the frame.

When the sampling device (106) is connected to a processing unit (204), a processing unit processor (351) reads each frame from the memory (110) of the sampling device (106) and decrypts the identification tag (305) using a private key (356). In addition, the identification code (304) is transferred from the memory (110) of the sampling device (106). The image data (307) is stored in the processing unit memory (359) with a decrypted identification tag (355). As each frame is processed by the processing unit processor (351), the decrypted identification tag is checked to ensure that it contains the identification code (304) of the sampling device (106) and the date and time of the frame as contained in the image data for the frame. This way, it can be determined whether any of the frames have been removed, manipulated or inserted from the memory (110) of the sampling device (106) in-between sampling of the frames and connection to the processing unit (204).

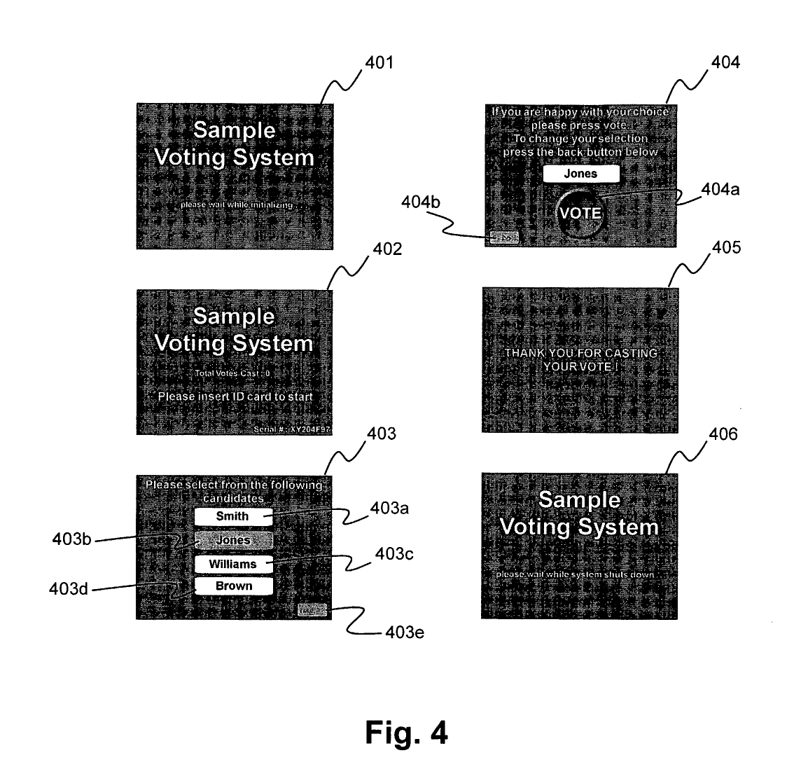

FIG. 4 shows first to sixth screens (401, 402, 403, 404, 405 and 406) of a user interface implementing an electronic voting system (Sample Voting System) according to the present invention. The Sample Voting System (SVS) is software that is executable on the computing apparatus (101). The SVS allows a user to input an ID card and vote for one candidate in an election.

A first screen (401) is a system initialisation screen which displays a “please wait while initialising” message to the user (i.e. voter) for 10 seconds while the system starts.

A second screen (402) is a start screen presented to the user prompting insertion of an ID card to commence the voting process. This screen also contains the serial number of the computing apparatus (101) and gives an indication of the total votes cast at a particular point in time.

A third screen (403) is a candidate selection screen which displays voting options to the voter. A candidate can be selected from the list by pressing a candidate button corresponding to each candidate (403a, 403b, 403c and 403d) and pressing a “next >>” button (403e). In the embodiment illustrated in FIG. 4, the voter has selected the “Jones” candidate by pressing the “Jones” button (403b).

A fourth screen (404) is a vote screen which allows the voter to review their selection. They either vote by pressing a vote button (404a), or navigate back to the third screen (403) with the “<< back” button (404b).

A fifth screen (405) is a thank-you screen which is displayed for five seconds before returning to the second screen (402) to wait for a new voter to cast their vote.

A sixth screen (406) is a system shutdown screen which is only displayed when the touch screen election hardware is shut down.

There are four stages involved with analysing video data stored in the sampling device (106), specifically:

Stage 1: creating a workflow engine to identify screens of interest;

Stage 2: extracting the screens of interest from the video data using Unique Keys created in stage 1;

Stage 3: extracting data and image regions of interest from the extracted screens;

Stage 4: produce reports.

In stage 1, the data required to verify the SVS operation is defined first to allow the creation of the workflow engine which is responsible for extracting the screens of interest and regions of interest for reporting. An initial analysis is carried out on the functionality of the computing apparatus (101). This analysis comprises:

1) determining the sequence of screens displayed by the computing apparatus (101) which are involved with each unique process or transaction;

2) creating unique keys to identify each screen of interest (significant frame);

3) modelling the workflow of the user interface to ensure the required screens are captured (significant frames).

A workflow model is then created by a supervisor which allows significant screens to be identified and the correct instance of a screen to be analysed for regions of interest within each significant frame.

In stage 2, a specification of identified significant frames is produced from the workflow model. Video data is reduced to individual video frames for identification processing using the unique keys produced in stage 1. The frame rate at which video frames are extracted is equal to or less than the frame rate of the computing apparatus (101) (video generation device). For example, source video data at 25 fps (frames per second) allows the capture of 25 individual video frames per second for processing. However, where possible video frames can be dropped and only every fifth video frame extracted.

The extracted video frames are compared to the unique keys and marked for further processing. A filtering process takes place that retains only the last clean frame of the screen. To avoid data extraction on a corrupted screen, the workflow rolls back a predetermined number of video frames to pick up the last clean frame.

A given screen can be generated by the computing apparatus (101) for a number of seconds. After the video frame extraction process, there will be multiple versions of the same screen stored in the memory (110). The workflow engine determines the clean frame capture point. In most instances it will be the last clean frame, but the workflow engine allows extraction at any point within the video frames.

In stage 3, the processing unit (204) produces a collection of marked video frames for data extraction based on the specification provided by the workflow model. Depending on the nature of the screen (i.e. the data it contains), the screen may be further processed to extract regions of interest. The regions of interest (significant regions) are identified by non-proprietary image analysis, for example presenting each identified significant frame to histogram identification or mathematical comparison functions or by extracting pre-defined screen co-ordinates within each identified significant frame.

In stage 4, extracted regions of interest are processed with a reporting engine to either count the occurrences of a region of interest, or display the regions of interest in context within a report. See example for further details.

In this way, the present invention allows the following information to be identified independently from the data logged by the computing apparatus:
1) the date of the election;
2) the time when the computing apparatus was turned on or the voting software started;
3) the time when the computing apparatus was turned off or the voting software ended;
4) the serial number of the computing apparatus or voting software;
5) that the vote count is at zero at the start of the election;
6) the number of votes cast on the computing apparatus; and
7) the total votes for the candidates on the computing apparatus.

FIG. 5 shows an example of how the second screen (402) is identified as a significant frame. A unique key (501) which has been previously identified and stored by software in the processing unit (204) is used to identify the second screen. As each video frame is processed, it is compared to the unique key and if it is identified as a significant frame, it is marked for further processing.

The unique key (504) is defined by an area in the second screen that is unique within the entire SVS software application. In this instance, the text “Please insert ID card to start” does not appear anywhere else in the SVS application. Therefore, this area of the second screen characterises the second screen.

Depending on the current position within the workflow process, unique keys may or may not be used to identify the screen of interest. For example once the first screen (401) has been captured, there is no need to compare subsequent video frames with a unique key for the start screen.

The unique key (501) is stored in the workflow model as image data with an associated screen identifier. The processing device (204) scans each frame from the video data stored in the memory (108) and attempts to match the unique key (501) with the frame being scanned. When the unique key (501) is matched with image data in the frame, a pointer to the frame is inserted in a lookup table of significant frames stored in memory of the processing device (204).

Turning to each of the screens implemented in the Sample Voting System (SVS) described in FIG. 4, reference is now made to the information extracted from each screen during further processing by the processing device (204).

The first screen (401) is processed to:

1) identify the date of an election; and

2) identify the time when the SVS computing apparatus was turned on.

The video data has an absolute time reference embedded into each video frame. The absolute time reference is generated and stored in the memory of the sampling unit. The date and time from the video data at the point when the first screen appears provides reporting data for items 1 and 2 above.

The second screen (402) is processed to:

3) identify the serial number of the sample voting system touch election hardware (i.e. serial number of the computing apparatus (101));

4) identify that the SVS computing apparatus vote count is at zero at the start of the election;

5) identify how many votes were cast on the SVS computing apparatus.

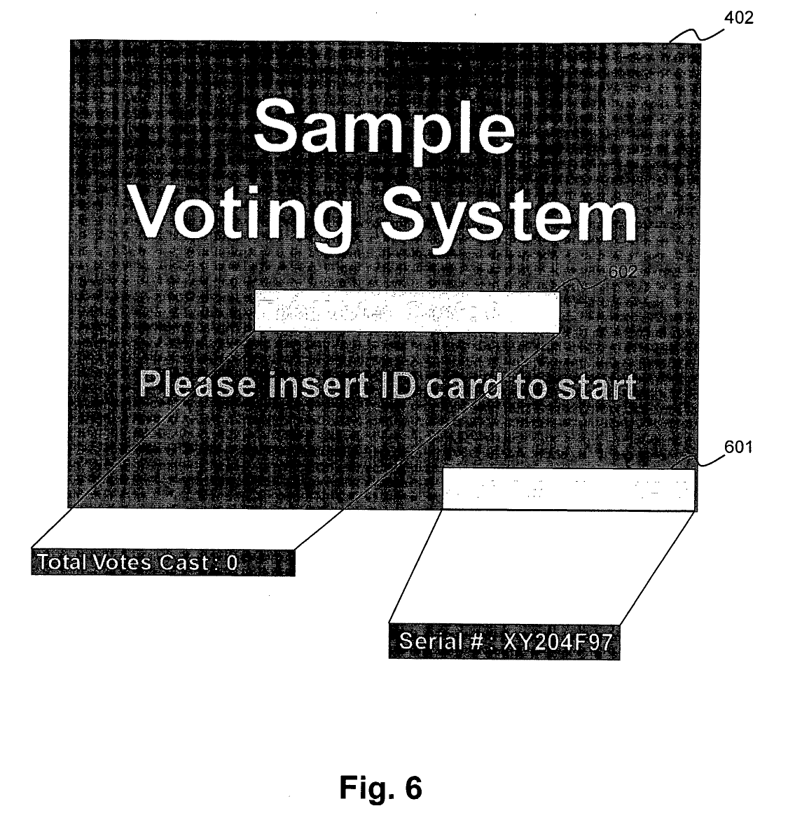

Reference is made to FIG. 6, in which first and second regions of interest (significant regions) (601, 602) are in the second screen (402). The serial number is extracted from the first region of interest (601) (significant region) from the first occurrence of the second screen (402) in the video data. The serial number is always positioned at the same location on the screen, so absolute co-ordinates are used to define the first region of interest and capture the serial number.

Identifying the vote count is achieved by capturing the first occurrence of the second screen (402) in the video data and identifying the total number of votes cast from the second region of interest (602). The total number of votes cast is always positioned at the same location on the screen, so absolute co-ordinates are used to capture the initial votes cast.

The fourth screen (404) is processed to:

6) identify the total number of votes for each of the candidates.

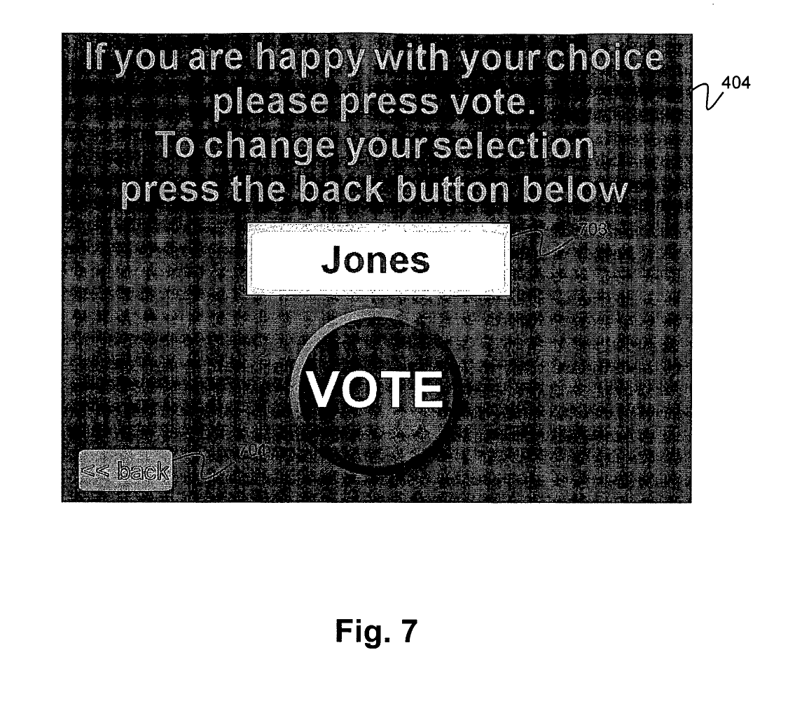

FIG. 7 shows the fourth screen in detail and a third region of interest (703). The sequence of screens for each vote can differ slightly as the voter has the ability to use the “<< back” button (701) to revise the selection. Capturing the actual vote made by a user is done by identifying the last occurrence of the fourth screen (404) before the fifth screen (405) appears in the video data. The fifth screen (405) indicates a vote has been cast. Therefore, the last occurrence of the fourth screen (404) shows the valid vote that has been cast.

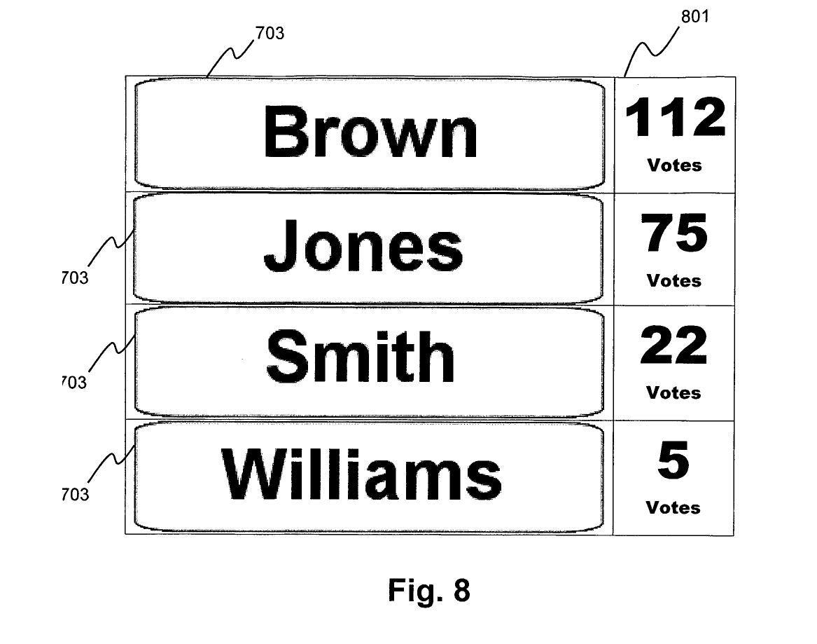

Identifying the number of votes cast (c.f. FIG. 8) for a particular candidate is achieved by extracting the first instance of the third region of interest for each candidate and counting the subsequent occurrences of the third region of interest (703) in each voting sequence by incrementing a value in a lookup table having a record of each region of interest for each candidate.

The fifth screen (405) is displayed for five seconds before returning to the second screen (402) to wait for a new voter to cast their vote. This screen is required to ensure the correct version of the fourth screen (404) is captured.

The sixth screen (406) is displayed for 5 seconds when the touch screen election hardware is shut down. Analysis of the sixth screen (406) is required to identify the time when the SVS computing apparatus was turned off.

The video data has an absolute time reference embedded into each video frame. Extracting the date and time from the video data at the point when the sixth screen last appears in the video data identifies the time when the SVS computing apparatus was turned off.

Reference is now made to FIG. 8. A reporting engine executable on the processing device (204) correlates regions of interest from the video data in each sampling device connected to the processing device (204) and produces various reports.

FIG. 8 shows an Election Results report (801) listing the total number of votes cast for each candidate. In the embodiment shown in FIG. 8, the processing unit (204) identifies different third regions of interest (703) and matches each identified third region (703) on each screen to determine the total number of occurrences of each third region in a voting sample. It should be noted that, in this one embodiment of the invention, no intelligent character recognition of the candidate's name is carried out. In the Election Results report (801), only the graphical image corresponding to each identified third region (703) is displayed with an indication of the total number of votes cast.

Examples of other reports are:—

SVS Unit Report—listing all the serial numbers of the SVS touch screen hardware units used for an election.

SVS Unit Election Results—listing the candidate totals for a specific serial number of an SVS touch screen hardware unit.

Start/Stop Time—listing all serial numbers of the SVS touch screen units with their respective start/stop times and dates.

The workflow engine can accommodate any combination of reports if required data is presented on screen at a point during operation.

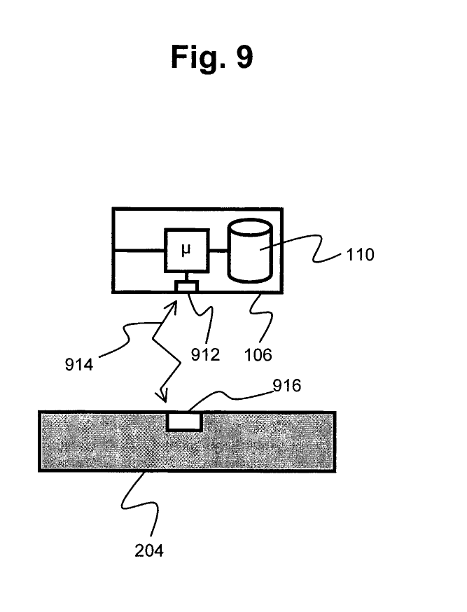

FIG. 9 shows an alternative embodiment to the invention shown in FIG. 2. The sampling device (106) comprises a first wireless data transceiver (912) and the processing unit (204) comprises a second wireless transceiver (916). There is no electrical connection between the sampling device (106) and the processing unit (204). Instead, the processing unit (204) accesses the memory (110) of the sampling device (106) via a wireless data link (914) and can receive video data from the memory (110) via the wireless data link (914). In this way, one or more sampling devices (106) can remain connected in situ to computing apparatus (101) whilst video data is analysed by the processing unit (204).

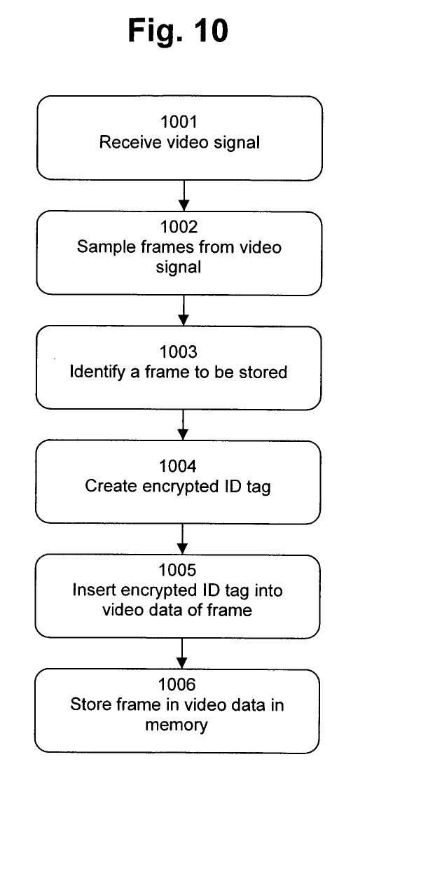

FIG. 10 shows the steps carried out during sampling of a video signal. In step 1001, an analogue video signal generated by the computing apparatus (101) is received by the processor (108) of the sampling device (106). In step 1002, each frame in the video signal is extracted from the signal in real-time and converted into a digital data stream. In step 1003, the digital data stream is processed to identify frames to be stored in memory (110). Frames may be stored periodically or the contents of a particular frame analysed to determine whether that frame needs to be stored. In step 1004, an encrypted identification tag is created for each frame that is to be stored and inserted in step 1005 as a header to the image data. The entire frame data (including image data and associated header) is then stored in the memory (110) in step 1006.

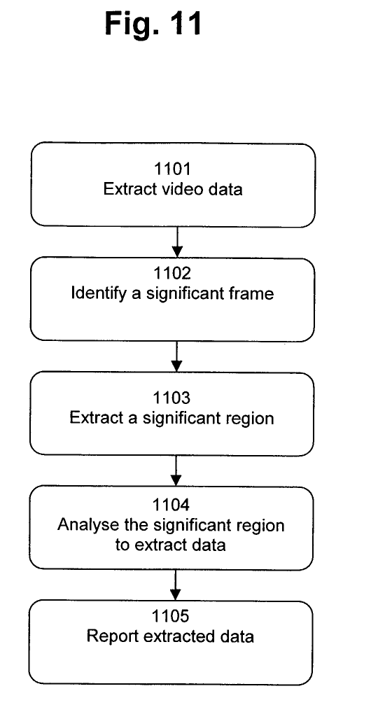

FIG. 11 shows the steps carried out during analysis of stored video data by a processing device (201). In step 1101, the processing unit (204) extracts video data from the memory (110) of the sampling device (106). In step 1102, each significant frame within the video data is identified and, if the frame is significant, in step 1103, a significant region of the frame may be extracted to provide data for analysis in step 1104. Data resulting from analysis is reported in step 1105 once all the video data from the sampling device (106) has been processed.

It will of course be understood that the present invention has been described above purely by way of example and that modifications of detail can be made within the scope of the invention.

### Terminology

Video Generation Unit/Source Apparatus—apparatus that produces a video output signal. In the described embodiment, the video generation unit is computing apparatus.
Sampling Unit/Video Capture Unit (VCU)—the hardware video capture unit used to record the video output signal from the source apparatus.
Video Data/Digital Video Stream (DVS)—the digital recording of a video output signal from a source apparatus by a VCU.
Workflow Engine—an algorithm that is created to accommodate the different functionality of the source apparatus. This algorithm defines what data to collect from the video data.
Election Event—an election that a VCU is configured specifically to capture.
Video Frame—video data consists of individual video frames displayed at multiple times a second. A video frame in the context of this document is graphical screen instance in time displaying the information displayed on-screen to a user of the source apparatus.
Clean Frame—image corruption can occur during the transition between one screen to another as the video frame capture isn't in sync with the source apparatus output refresh rate. A clean frame is one without this corruption.
Screen—a specific software video frame displaying information or requesting input from a user.
Screen of Interest/Significant frame—a screen that contains data required for reporting.
Region of Interest/Significant region—a graphical area on a screen of interest to be used in reporting.
Unique Key—a graphical “region of interest” (significant region) that is unique to a screen. The unique key is used to identify which screen is currently being analyzed.

1. Apparatus for receiving images from a video generation device comprising:
a video link through which a video signal from a video generation device is received in use;
a memory for storing video data; and
a processor connected to the video link configured to sample frames in the video signal, to process sampled frames to generate video data for storage in the memory and further configured to embed an identification tag within the video data.

2. The apparatus of claim 1, wherein the identification tag characterises the apparatus being used.

3. The apparatus of claim 1 or claim 2, wherein the processor is configured to embed the identification tag in every frame stored in the memory.

4. The apparatus of any one of the preceding claims, wherein each image corresponds to a screen of a user interface generated by the video generation device.

5. The apparatus of any one of the preceding claims, wherein the processor is configured to store in the memory only video data for sampled frames differing to a previously sampled frame.

6. The apparatus of any one of the preceding claims, wherein the processor is configured to embed the identification tag as a digital signature within the video data.

7. The apparatus of any one of claims 1 to 5, wherein the processor is configured to embed the identification tag a graphical identification tag within the video data.

8. The apparatus of claim 7, wherein the graphical identification tag comprises a watermark image for embedding in a frame of the video data.

9. The apparatus of any one of the preceding claims, wherein the processor is further configured to encrypt the identification tag before embedding the identification tag in the video data.

10. The apparatus of claim 9, wherein the processor is configured to encrypt the identification tag using a public key stored in the memory of the image generation device.

11. A method for storing images from a video generation device comprising the steps of:
receiving a video signal from a video generation device at a sampling device;
sampling frames encoded in the video signal;
embedding an identification tag within the video data of the video signal; and
storing the video data in memory.

12. The method of claim 11, wherein the identification tag characterises the sampling device.

13. The method of claim 11 or claim 12, wherein the step of embedding comprises embedding the identification tag in every frame of the video data.

14. The method of any one of claims 11 to 13, wherein each frame corresponds to a screen of a user interface generated by the video generation device.

15. The method of any one of claims 11 to 14, wherein the step of storing comprises storing in the memory only video data for sampled frames which differ to the previously sampled frame.

16. The method of any one of claims 11 to 15, wherein the step of embedding comprises the steps of: generating a digital signature; and inserting the digital signature into the video data.

17. The method of any one of claims 11 to 16, wherein the step of embedding comprises the steps of: generating a graphical identification tag; and
applying the graphical identification tag to the video data.

18. The method of claim 17, wherein the step of applying comprises overlaying the graphical identification tag as a watermark on frames within the video data.

19. The method of any one of claims 11 to 17, further comprising the step of encrypting the identification tag before the step of embedding.

20. The method of claim 19, wherein the step of encrypting comprises applying a public key stored in the memory of the video generation device to the identification tag.

21. The method of any one of claims 11 to 20, further comprising the steps of:
connecting the sampling device to a processing device after storing video data in the memory;
receiving into the processing device the stored video data from the memory; and
in the processing device, analysing the stored video data to determine the presence in the video data of at least one identification tag, thereby determining whether the video data has been tampered with.

22. The method of claim 21, wherein the step of analysing comprises determining whether every image in the video data includes the identification tag.

23. The method of claim 20 or claim 21 when dependent on claim 19 or claim 20, wherein the step of analysing comprises decrypting the encrypted identification tag.

24. The method of claim 23 wherein the step of decrypting comprises applying a private key stored in the processing unit to the identification tag.

25. A system for analysing video data generated by a video generation device comprising:
the apparatus of any one of claims 1 to 10; and
a processing unit for connecting to the apparatus and configured to receive the stored video data from the memory of the apparatus and analyse the stored video data to determine the presence in the video data of at least one identification tag, thereby determining whether the video data has been tampered with.

26. A method for analysing stored video data including a plurality of sampled video frames of a user interface, comprising:
identifying a significant frame within the plurality of sampled video frames;
extracting a significant region within the identified significant frame;
analysing the extracted significant region to extract data representative of user interaction with the user interface.

27. The method of claim 26, wherein the step of analysing comprises identifying a change in characteristic of the significant region.

28. The method of claim 27, wherein the change in characteristic is a change in colour or texture of the significant region.

29. The method of claim 26, wherein the step of analysing comprises processing video data for the identified significant region to extract data input via the user interface.

30. The method of claim 26, wherein the step of analysing comprises processing video data for the identified significant region to extract identification data for graphical markers inserted into the video data by a sampling device.

31. The method of claim 30, further comprising the step of determining the identity of the sampling device from the identification data.

32. The method of claim 31, wherein the step of determining the identity comprises decrypting an identification tag from the identification data.

33. The method of any one of claims 26 to 32, wherein the step of analysing comprises determining the number of occurrences of a significant region within an identified significant frame.

34. The method of any one of claims 26 to 33, wherein the step of identifying a significant frame comprises comparing each sampled video frame to image data representative of a section of a significant frame.

35. The method of any one of claims 26 to 33, wherein the step of identifying a significant frame comprises comparing each sampled video frame to image data representative of the whole of a significant frame.

36. The method of any one of claims 26 to 35, wherein the step of extracting comprises extracting a region of the identified significant frame defined by coordinates specifying a position and size of the significant region.

37. The method of any one of claims 26 to 35, wherein the step of extracting comprises extracting a region of the identified significant frame defined by one or more characteristics of the identified significant frame.

38. The method of claim 37, wherein the one of the characteristics is a colour or texture of the identified significant frame.

39. The method of any one of claims 26 to 38, further comprising the step of analysing the identified significant region to extract data corresponding to the sampling of the video frames.

40. A computer program comprising computer executable instructions for implementing the method as claimed in claims 26 to 39.

41. A processing unit configured to perform the steps of the method as claimed in claims 26 to 39.

42. A system for validating electronic voting made via computer apparatus which records votes as first data, comprising:
a sampling device configured to connect to the computer apparatus and store second data representative of the votes independently from the first data; and
a processing device configured to connect with the device and analyse the stored second data to determine the validity of the voting.

43. The system as claimed in claim 42, wherein the processing device is configured to determine the validity of the voting by comparing the first data to the second data.

44. The system as claimed in claim 42, wherein the processing device indicates that the voting is invalid if results of voting ascertained from the first data differ from results of voting ascertained from the second data.

45. The system as claimed in any one of claims 42 to 44, wherein the processing device and the sampling device both comprise a wireless transceiver and connect to each other over wireless link.

46. The system as claimed in any one of claims 42 to 45, wherein the first data is video data comprising images of a user interface displayed by the computing apparatus for voting.

47. A method for validating electronic voting made via computer apparatus, comprising:
storing independently from the computer apparatus data on the; and
analysing the stored data to determine the validity of the voting.

48. The apparatus of any one of claims 1 to 10, wherein the video generation unit is computing apparatus with a video output to which the video link is connected in use, wherein the computing apparatus is configured to execute electronic voting system software which generates voting data on the computing apparatus in use.

49. The apparatus of any one of claims 1 to 10, wherein the apparatus is dimensioned to be portable.
